(19) United States
(12) Patent Application Publication
(10) Pub. No.: US 2025/0203463 A1
(43) Pub. Date: Jun. 19, 2025

(54) SYSTEMS AND METHODS FOR MANAGING BANDWIDTH ALLOCATION IN A WIRELESS NETWORK

(71) Applicant: T-Mobile Innovations LLC, Overland Park, KS (US)

(72) Inventor: Jasinder P. SINGH, Olathe, KS (US)

(21) Appl. No.: 18/544,989

(22) Filed: Dec. 19, 2023

(51) Int. Cl. H04W 28/20; H04W 28/02; H04W 72/21; H04W 72/52

(52) U.S. Cl. CPC H04W 28/20; H04W 28/0289; H04W 72/21; H04W 72/52

(57) ABSTRACT

Systems and methods are provided for managing bandwidth in a wireless network. The methods include monitoring a capacity usage of an uplink control channel. The methods further include lowering a bandwidth part (BWP) in one or more secondary carriers for users if the capacity usage is still above the threshold, and then downgrading a carrier aggregation level for the users if the usage capacity is still above the threshold. This process may be performed on roaming and high bandwidth users first before proceeding to regular home network users if the usage capacity of the uplink control channel is still above the threshold.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). RATS may additionally include, for example, Wi-Fi and Bluetooth. Additionally, different standards may be implemented, including one or more International Engineering Task Force (IETF) standards; one or more of the Institute of Electrical and Electronics Engineers (IEEE) 802.11 standards; and/or any other industry standards and/or specifications. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

A carrier may be configured for each of the different RATs and it may be configured for different frequency ranges. For example, the 5G spectrum may be divided into high, medium, and low frequency bands, each with one or more carriers. Modern mobile devices are capable of interacting with multiple carriers. Carrier aggregation is a common method of improving performance for wireless users by allowing the mobile device to utilize multiple carriers at the same time, thus increasing the amount of data that can be transmitted at the same time. With so many mobile devices all trying to use all available carriers at the same time, it is possible to overload the provider's network and steps need to be taken to gracefully manage the high loads.

### OVERVIEW

Examples described herein include systems and methods for managing bandwidth allocation in a wireless network. An exemplary method includes monitoring a capacity usage of an uplink control channel. The method further includes upon determining that the capacity usage of the uplink control channel is above a threshold, lowering a Bandwidth Part (BWP) in one or more secondary carriers for one or more roaming users and one or more heavy bandwidth users. The method may further include upon determining that the capacity usage of the uplink control channel is still above the threshold after lowering the BWP in one or more secondary carriers for the one or more roaming users and the one or more heavy bandwidth users, downgrading a carrier aggregation level for the one or more roaming users and the one or more heavy bandwidth users. The method may further include upon determining that the capacity usage of the uplink control channel is still above the threshold after downgrading the carrier aggregation level for the one or more roaming users and the one or more heavy bandwidth users, lowering a BWP in one or more secondary carriers for one or more home network users. The method may further include upon determining that the capacity usage of the uplink control channel is still above the threshold after lowering the BWP in one or more secondary carriers for the one or more home network users, downgrading a carrier aggregation level for the one or more home network users.

Another exemplary embodiment includes a system including an access node which includes at least one electronic processor configured to perform operations. The operations include monitoring a capacity usage of an uplink control channel. The operations further include upon determining that the capacity usage of the uplink control channel is above a threshold, lowering a Bandwidth Part (BWP) in one or more secondary cells for one or more roaming users and one or more heavy bandwidth users. The operations further include upon determining that the capacity usage of the uplink control channel is still above the threshold after lowering the BWP in one or more secondary cells for the one or more roaming users and the one or more heavy bandwidth users, downgrading a carrier aggregation level for the one or more roaming users and the one or more heavy bandwidth users. The operations further include upon determining that the capacity usage of the uplink control channel is still above the threshold after downgrading the carrier aggregation level for the one or more roaming users and the one or more heavy bandwidth users, lowering a BWP in one or more secondary cells for one or more home network users. The operations further include upon determining that the capacity usage of the uplink control channel is still above the threshold after lowering the BWP in one or more secondary cells for the one or more home network users, downgrading a carrier aggregation level for the one or more home network users.

Another exemplary method includes monitoring a capacity usage of a Physical Uplink Control Channel (PUCCH). The method further includes upon determining that the capacity usage of the PUCCH is above a threshold, lowering a Bandwidth Part (BWP) in one or more secondary cells (SCells) for one or more roaming users and one or more heavy bandwidth users. The method further includes upon determining that the capacity usage of the PUCCH is still above the threshold after lowering the BWP in one or more SCells for the one or more roaming users and the one or more heavy bandwidth users, downgrading a carrier aggregation level for the one or more roaming users and the one or more heavy bandwidth users. The method further includes upon determining that the capacity usage of the PUCCH is still above the threshold after downgrading the carrier aggregation level for the one or more roaming users and the one or more heavy bandwidth users, lowering a BWP in one or more SCells for one or more home network users. The method further includes upon determining that the capacity usage of the PUCCH is still above the threshold after lowering the BWP in one or more SCells for the one or more home network users, downgrading a carrier aggregation level for the one or more home network users.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary processing node in accordance with various aspects of the present disclosure;

FIG. 3 illustrates an exemplary access node in accordance with various aspects of the present disclosure;

FIG. 4 illustrates an exemplary process flow for managing bandwidth allocation in a wireless network; and

FIG. 5 illustrates an exemplary process flow for managing bandwidth allocation in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by an access node. Access nodes provide several frequency bands for providing service. Lower frequency bands give higher coverage areas, but lower data throughput. Higher frequency bands give smaller coverage areas, but higher data throughput. These frequency bands may be configured as carriers. For example, an access node may provide a carrier with a low frequency band and a carrier with a high frequency band. Modern wireless devices have the ability to access multiple carriers at a time. By aggregating these different carriers, a more robust service may be provided to the users of the wireless network. For example, by accessing multiple carriers, a wireless device would have access to the data throughput of the sum of the throughput offered by the carriers the wireless device is connected to. The wireless device would also be more likely to maintain a network connection while travelling across the coverage area of an access node or between coverage areas of multiple access nodes.

In carrier aggregation (CA), each carrier is called a component carrier (CC). There is always one primary component carrier (PCC), and any remaining carriers are secondary component carriers (SCC). The PCC is serviced by the primary cell (PCell), and the one or more SCCs are serviced by a corresponding number of secondary cells (SCell). All uplink data, including control signaling, is sent on the PCC, while all other traffic, including downlink data, is sent on the PCC or the one or more SCCs. That means the Physical Uplink Control Channel (PUCCH) is always on the PCC. The PUCCH traffic increases as more SCCs are added to the CA pool. The PUCCH traffic may become the limiting factor to CA as the number of cells go up. In the current system, if the PUCCH traffic saturates the PCC, it is dealt with by downgrading the CA. For example, if the CA pool includes 5 CCs, one CC may be dropped from the pool, leaving 4CCs. Since one less CC is being serviced, the PUCCH traffic will be reduced potentially alleviating the problem.

In Release 15, the 3GPP specified some new features for 5G, including Bandwidth Parts (BWP). Before BWP, a wireless device using a carrier, would use the full bandwidth of the carrier whenever it was transmitting via that carrier. This is not bandwidth efficient and since it takes more power to transmit the full bandwidth, it is wasteful of power as well. Wireless devices tend to run on battery power and therefore that battery life is precious and should not be wasted. With BWP, the full bandwidth of a carrier can be broken into as many as 4 separate BWPs. Each BWP can have its own configuration and allows for a much more efficient use of bandwidth and power. This can help preserve the battery life of wireless devices. Additionally, BWP can help support legacy devices that might not support the new bandwidths introduced with 5G. For example, a BWP may be setup that is configured to support legacy 4G devices. The 4G devices can be serviced and the remainder of the carrier is available to service other wireless devices. Part of the efficiency improvement of BWP is that a wireless device may be configured to use only as much bandwidth as necessary instead of using the whole bandwidth of the carrier. This flexibility allows the device to use higher bandwidth BWPs as the data requirements increase. A BWP may be increased in size as needed and may be lowered in size as needed,

By using BWP and CA together, an even more efficient method of managing bandwidth is possible. Instead of immediately dropping a CC when the PUCCH traffic saturates the PCC, manipulating BWP within the SCCs first can lead to a more efficient use of bandwidth. Initially, start with the largest possible BWP but when the PUCCH channel gets saturated, the BWP can be decreased in steps. This will decrease the amount of data being transmitted on the SCCs, therefore reducing the control traffic on the PUCCH. A threshold usage capacity may be defined, above which the PUCCH is considered saturated. This threshold could be set to any value the provider wants and could even be dynamic. For example, the threshold could be set to any percentage of capacity, and it could be set to different values during different times of day or different days of the week. The threshold is very flexible.

The uplink control channel, such as the PUCCH, may be monitored continuously or at any useful intervals. If the uplink control channel capacity usage is above the threshold, the BWP may be lowered in one or more of the secondary cells. Lowering the BWP may be done incrementally until reaching the smallest supported BWP. To further improve the granularity, this could initially apply only to roaming users and/or heavy bandwidth users. After the BWP has been lowered to the smallest supported BWP, if the capacity usage of the uplink control channel is still above the threshold, the CA may be downgraded by removing a secondary cell from CA. Again, to further improve the granularity, this could initially apply only to roaming users and/or heavy bandwidth users. If the capacity usage of the uplink control channel is still above the threshold and the mitigation strategies mentioned above have been limited to the roaming users and the heavy users, they may be applied to other others. For example, the BWP may be lowered in one or more secondary cells for users in their home networks. If the BWP is lowered to the smallest supported BWP for the home users and the capacity usage is still above the threshold, the home users could then have their CA downgraded by removing a secondary cell.

A user may be identified as roaming or home users by querying their PLMN. A home user would be in an H-PLMN and a roaming user would be in a V-PLMN. One method of identifying heavy users would be by the Quality of Service (QoS) level assigned to the user. Particularly heavy data users tend to be separated out by QoS by the provider. Fixed wireless users (also known as cellular home internet users) may be excluded from the pool of home network users in order to maintain their level of service and due to the fact that there are very few of them per cell.

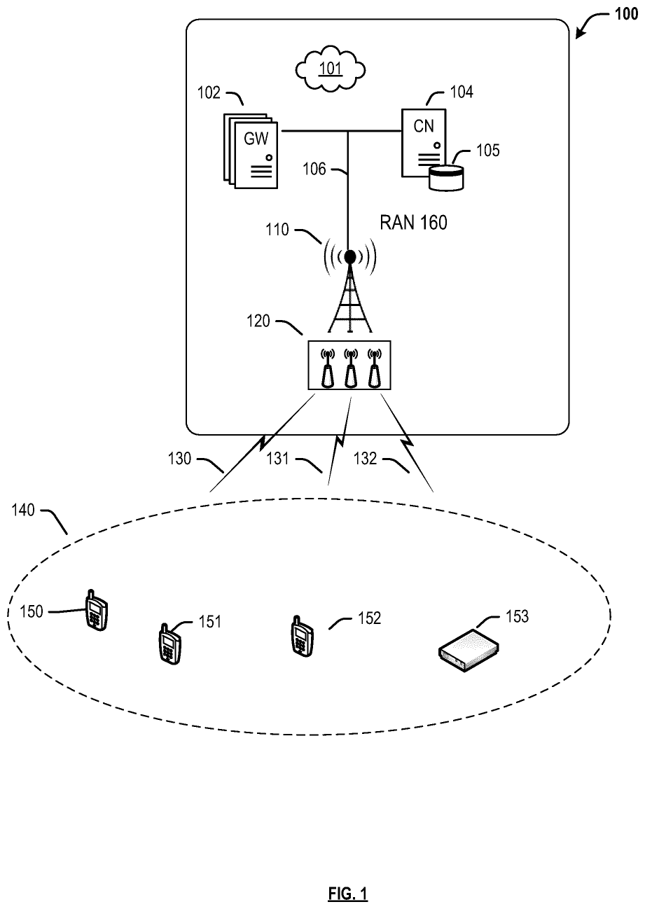

FIG. 1 depicts an exemplary system 100 for managing bandwidth allocation in a wireless network. System 100 includes a communication network 101, gateway node(s) 102, controller node 104, access node 110, and wireless devices 150-153. Access node 110 can be any network node configured to provide communication between wireless devices 150-153 and communication network 101, including standard access nodes and/or short range, low power, small access nodes. Access node 110 has a coverage area 140 within which it provides service to the wireless devices 150-153.

Access node 110 may include any standard access node, such as a macrocell access node, base transceiver station, a radio base station, an eNodeB device, an enhanced eNodeB device, a next generation or gigabit NodeB device (gNBs) in 5G networks, or the like. In other embodiments, access node 110 can be a small access node including a microcell access node, a picocell access node, a femtocell access node, or the like such as a home NodeB, home eNodeB or home gNodeB device. By virtue of comprising a plurality of antennae 120 as further described herein, access node 110 can deploy or implement different radio access technologies (RATs) such as 3G, 4G, 5G, sub-6G, mm-wave, as well as transmission modes including multiple-input-multiple-output (MIMO), single user MIMO (SU-MIMO), multi-user MIMO (MU-MIMO), etc. While three antennae are shown in the array 120, any number of antennae may be included in the array 120. Moreover, each of wireless devices 150-153 can also be equipped with a plurality of antennae enabling these different types of transmissions.

For example, each of wireless devices 150-153 may be capable of simultaneously communicating with access node 110 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices can be implemented.

Wireless devices 150-153 may be any device, system, combination of devices, or other such communication platform capable of communicating on the wireless network using one or more frequency bands deployed therefrom. Each wireless device 150-153 may be, for example, a mobile phone, a wireless phone, a cellular home internet modem, a personal digital assistant (PDA), a voice over internet protocol (VOIP) phone, a voice over packet (VOP) phone, or a soft phone, as well as other types of devices or systems that can exchange audio or data via the wireless network. Other types of communication platforms are possible. Communication channels 130-132 may be configured as component carriers with carrier 130 being the primary carrier and carriers 131-132 being secondary carriers, for example. Three carriers are shown for clarity, but any number of carriers may be used.

In operation, access node 110 may be configured to execute a method including monitoring a capacity usage of an uplink control channel. The method may further include, upon determining that the capacity usage of the uplink control channel is above a threshold, lowering a Bandwidth Part (BWP) in one or more secondary carriers 131-132 for one or more roaming users and one or more heavy bandwidth users. The method may further include, upon determining that the capacity usage of the uplink control channel is still above the threshold after lowering the BWP in one or more secondary carriers 131-132 for the one or more roaming users and the one or more heavy bandwidth users, downgrading a carrier aggregation level for the one or more roaming users and the one or more heavy bandwidth users. The method may further include, upon determining that the capacity usage of the uplink control channel is still above the threshold after downgrading the carrier aggregation level for the one or more roaming users and the one or more heavy bandwidth users, lowering a BWP in one or more secondary carriers 131-132 for one or more home network users. The method may further include, upon determining that the capacity usage of the uplink control channel is still above the threshold after lowering the BWP in one or more secondary carriers 131-132 for the one or more home network users, downgrading a carrier aggregation level for the one or more home network users.

A user may be identified as roaming or home users by querying their PLMN. A home user would be in an H-PLMN and a roaming user would be in a V-PLMN. One method of identifying heavy users would be by the Quality of Service (QoS) level assigned to the user. Particularly heavy data users tend to be separated out by QoS by the provider. Fixed wireless users (also known as cellular home internet users) may be excluded from the pool of home network users in order to maintain their level of service and due to the fact that there are very few of them per cell.

The process of decreasing the BWP may comprise decreasing the BWP in increments while the capacity usage of the uplink control channel remains above the threshold until the BWP reaches the smallest supported size. This process may be the same whether decreasing the BWP of roaming, users, heavy bandwidth users, or home network users. The process of downgrading the carrier aggregation may comprise removing one of the secondary carriers 131-132 from the carrier aggregation. This process may be the same whether downgrading the carrier aggregation of roaming users, heavy bandwidth users, or home network users.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 communicates with gateway node 102 and controller node 104 via communication link 106. Access node 110 may communicate with other access nodes (not shown) using a direct link such as an X2 link or similar.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 150-153, etc. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication link 106 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications link 106 may include S1 communications links. Other wireless protocols can also be used. Communication link 106 can be a direct link or might include various equipment, intermediate components, systems, and networks. Communication link 106 may comprise many different signals sharing the same link.

Gateway node 102 can be any network node configured to interface with other network nodes using various protocols. Gateway node 102 can communicate user data over system 100. Gateway node 102 can be a standalone computing device, computing system, or network component, and can be accessible, for example, by a wired or wireless connection, or through an indirect connection such as through a computer network or communication network. For example, gateway node 102 can include a serving gateway (SGW) and/or a public data network gateway (PGW), a user plane function (UPF), etc. One of ordinary skill in the art would recognize that gateway node 102 is not limited to any specific technology architecture, such as Long Term Evolution (LTE) or 5G NR, and can be used with any network architecture and/or protocol.

Gateway node 102 can comprise a processor and associated circuitry to execute or direct the execution of computer-readable instructions to obtain information. Gateway node 102 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Gateway node 102 can receive instructions and other input at a user interface.

Controller node 104 can be any network node configured to communicate information and/or control information over system 100. Controller node 104 can be configured to transmit control information associated with a handover procedure. Controller node 104 can be a standalone computing device, computing system, or network component, and can be accessible, for example, by a wired or wireless connection, or through an indirect connection such as through a computer network or communication network. For example, controller node 104 can include a mobility management entity (MME), a session management function (SMF), a Home Subscriber Server (HSS), a Policy Control and Charging Rules Function (PCRF), an authentication, authorization, and accounting (AAA) node, a rights management server (RMS), a subscriber provisioning server (SPS), a policy server, etc. One of ordinary skill in the art would recognize that controller node 104 is not limited to any specific technology architecture, such as Long Term Evolution (LTE) or 5G NR, and can be used with any network architecture and/or protocol.

Controller node 104 can comprise a processor and associated circuitry to execute or direct the execution of computer-readable instructions to obtain information. Controller node 104 can retrieve and execute software from storage, which can include a disk drive, a flash drive, memory circuitry, or some other memory device, and which can be local or remotely accessible. In an exemplary embodiment, controller node 104 includes a database 105 for storing correlations of transmission types with antenna configurations, and so on. This information may be requested by or shared with access node 110 via communication link 106, X2 connections, and so on. The software comprises computer programs, firmware, or some other form of machine-readable instructions, and may include an operating system, utilities, drivers, network interfaces, applications, or some other type of software, and combinations thereof. Controller node 104 can receive instructions and other input at a user interface.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to access node 110, controller node 104, and/or network 101.

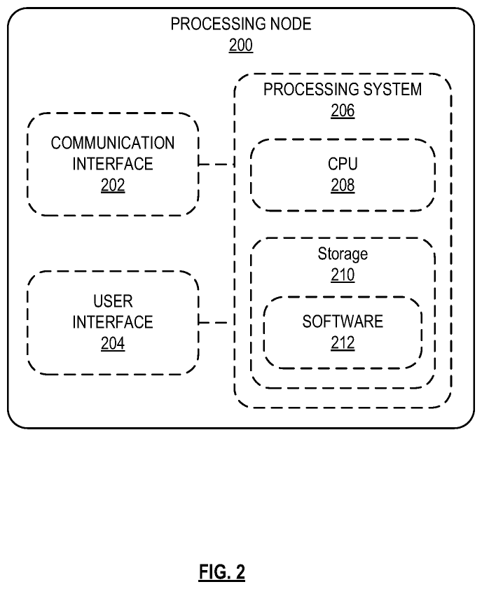

FIG. 2 depicts an exemplary processing node 200 for managing bandwidth allocation in a wireless network. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for monitoring a capacity usage of an uplink control channel. The instructions may further include upon determining that the capacity usage of the uplink control channel is above a threshold, lowering a Bandwidth Part (BWP) in one or more secondary cells for one or more roaming users and one or more heavy bandwidth users. The instructions may further include upon determining that the capacity usage of the uplink control channel is still above the threshold after lowering the BWP in one or more secondary cells for the one or more roaming users and the one or more heavy bandwidth users, downgrading a carrier aggregation level for the one or more roaming users and the one or more heavy bandwidth users. The instructions may further include upon determining that the capacity usage of the uplink control channel is still above the threshold after downgrading the carrier aggregation level for the one or more roaming users and the one or more heavy bandwidth users, lowering a BWP in one or more secondary cells for one or more home network users. The instructions may further include upon determining that the capacity usage of the uplink control channel is still above the threshold after lowering the BWP in one or more secondary cells for the one or more home network users, downgrading a carrier aggregation level for the one or more home network users.

A user may be identified as roaming or home users by querying their PLMN. A home user would be in an H-PLMN and a roaming user would be in a V-PLMN. One method of identifying heavy users would be by the Quality of Service (QoS) level assigned to the user. Particularly heavy data users tend to be separated out by QoS by the provider. Fixed wireless users (also known as cellular home internet users) may be excluded from the pool of home network users in order to maintain their level of service and due to the fact that there are very few of them per cell.

The process of decreasing the BWP may comprise decreasing the BWP in increments while the capacity usage of the uplink control channel remains above the threshold until the BWP reaches the smallest supported size. This process may be the same whether decreasing the BWP of roaming, users, heavy bandwidth users, or home network users. The process of downgrading the carrier aggregation may comprise removing one of the secondary carriers from the carrier aggregation. This process may be the same whether downgrading the carrier aggregation of roaming users, heavy bandwidth users, or home network users. The capacity usage threshold may be set at any useable value by the wireless network provider. It may be configured to be static or dynamic, including being different depending on the time of day, or day of the week, for example. The schedule for the dynamic threshold may be any useable schedule.

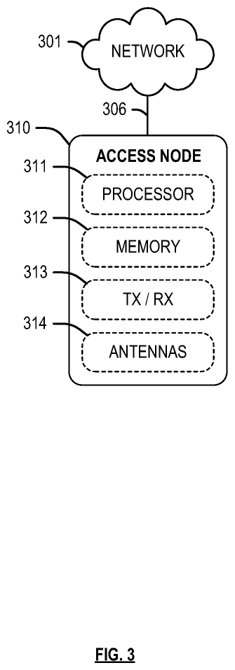

FIG. 3 depicts an exemplary access node 310 for providing wireless service in wireless networks. Access node 310 is configured as an access point for providing network services from network 301 to end-user wireless devices such as wireless devices 150-153 in FIG. 1. Access node 310 is illustrated as comprising a processor 311, a memory 312 for storing logical modules that perform operations described herein, and one or more transceivers 313 for transmitting and receiving signals via antennae 314. Combination of antennae 314 and transceivers 313 are configured to deploy one or more radio air interfaces using different RATs, frequencies, and/or operating modes. Additional transceivers and antennae may be incorporated in order to deploy 4G, 5G, mm-wave, SU-MIMO, MU-MIMO or massive MU-MIMO data streams to wireless devices attached to access node 310, as well as to facilitate communication with other network nodes on network 301. Further, access node 310 is communicatively coupled to network 301 via communication interface 306, which may be any wired or wireless link as described above. The one or more antennae 314 can include any combination of: antennae associated with different radio access technologies (RATs) (including 3G, 4G, 5G, 5G sub 6G, 5G millimeter wave), antennae associated with different arrays (including 2×2, 4×2, 4×4, 8×8, 16×16, 32×32, 64×64, 128×128, and so on), and beamforming antennae.

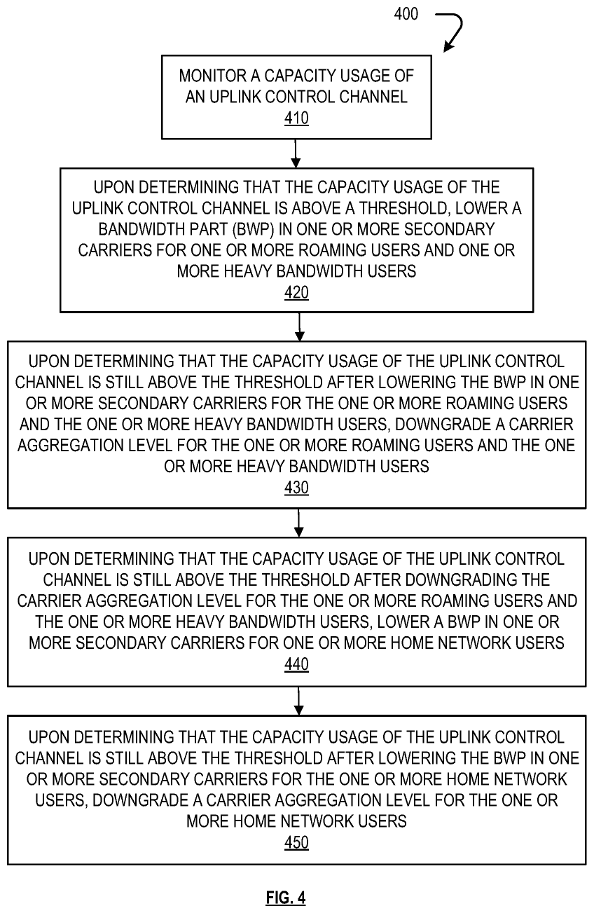

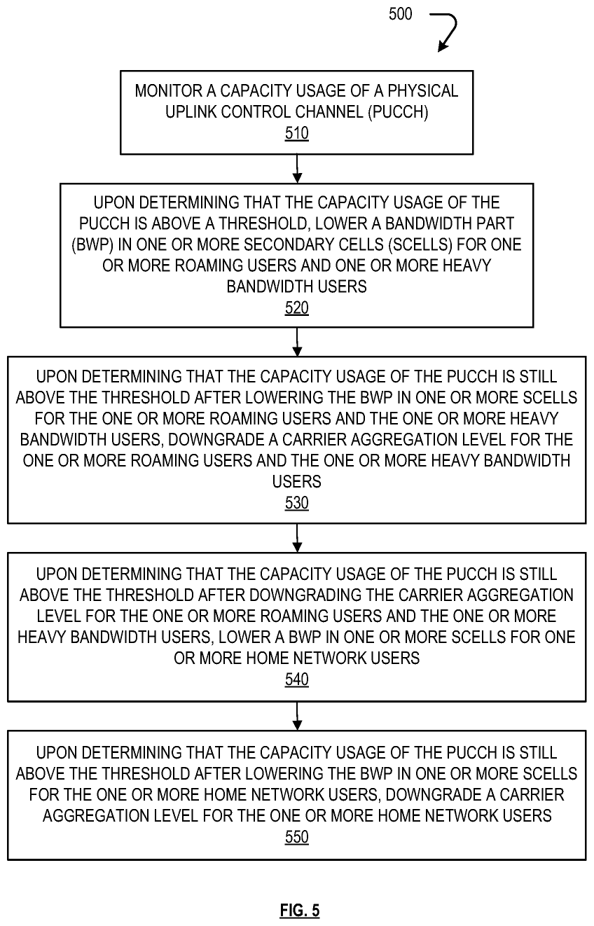

Access node 310 may be configured to perform the methods described herein including the methods described with respect to FIG. 4 and FIG. 5. The processor 311 of access node 310 may be configured to perform the instructions described herein including those described with respect to the processing node 200 of FIG. 2.

FIG. 4 illustrates an exemplary method 400 for managing bandwidth allocation in a wireless network. Method 400 may be performed by any suitable combination of processors, for example a processor contained in an access node such as access node 110, 310. In other embodiments, the method can be implemented with any suitable network element, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a capacity usage of an uplink control channel is monitored. Method 400 continues in step 420 where upon determining that the capacity usage of the uplink control channel is above a threshold, a Bandwidth Part (BWP) in one or more secondary carriers for one or more roaming users and one or more heavy bandwidth users is lowered. Method 400 may continue in step 430 where upon determining that the capacity usage of the uplink control channel is still above the threshold after lowering the BWP in one or more secondary carriers for the one or more roaming users and the one or more heavy bandwidth users, a carrier aggregation level for the one or more roaming users and the one or more heavy bandwidth users is downgraded. Method 400 may continue in step 440 where upon determining that the capacity usage of the uplink control channel is still above the threshold after downgrading the carrier aggregation level for the one or more roaming users and the one or more heavy bandwidth users, a BWP in one or more secondary carriers for one or more home network users is lowered. Method 400 may continue in step 450 where upon determining that the capacity usage of the uplink control channel is still above the threshold after lowering the BWP in one or more secondary carriers for the one or more home network users, a carrier aggregation level for the one or more home network users is downgraded.

A user may be identified as roaming or home users by querying their PLMN. A home user would be in an H-PLMN and a roaming user would be in a V-PLMN. One method of identifying heavy users would be by the Quality of Service (QoS) level assigned to the user. Particularly heavy data users tend to be separated out by QoS by the provider. Fixed wireless users (also known as cellular home internet users) may be excluded from the pool of home network users in order to maintain their level of service and due to the fact that there are very few of them per cell.

The process of decreasing the BWP may comprise decreasing the BWP in increments while the capacity usage of the uplink control channel remains above the threshold until the BWP reaches the smallest supported size. This process may be the same whether decreasing the BWP of roaming, users, heavy bandwidth users, or home network users. The process of downgrading the carrier aggregation may comprise removing one of the secondary carriers from the carrier aggregation. This process may be the same whether downgrading the carrier aggregation of roaming users, heavy bandwidth users, or home network users. The capacity usage threshold may be set at any useable value by the wireless network provider. It may be configured to be static or dynamic, including being different depending on the time of day, or day of the week, for example. The schedule for the dynamic threshold may be any useable schedule.

FIG. 5 illustrates an exemplary method 500 for managing bandwidth allocation in a wireless network. Method 500 may be performed by any suitable combination of processors, for example a processor contained in an access node such as access node 110, 310. In other embodiments, the method can be implemented with any suitable network element, such as processing node 200. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 500 begins in step 510 where a capacity usage of a Physical Uplink Control Channel (PUCCH) is monitored. Method 500 continues in step 520 where upon determining that the capacity usage of the PUCCH is above a threshold, a Bandwidth Part (BWP) in one or more secondary cells (SCells) for one or more roaming users and one or more heavy bandwidth users is lowered. Method 500 continues in step 530 where upon determining that the capacity usage of the PUCCH is still above the threshold after lowering the BWP in one or more SCells for the one or more roaming users and the one or more heavy bandwidth users, a carrier aggregation level for the one or more roaming users and the one or more heavy bandwidth users is downgraded. Method 500 continues in step 540 where upon determining that the capacity usage of the PUCCH is still above the threshold after downgrading the carrier aggregation level for the one or more roaming users and the one or more heavy bandwidth users, a BWP in one or more SCells for one or more home network users is lowered. Method 500 continues in step 550 where upon determining that the capacity usage of the PUCCH is still above the threshold after lowering the BWP in one or more SCells for the one or more home network users, a carrier aggregation level for the one or more home network users is downgraded.

A user may be identified as roaming or home users by querying their PLMN. A home user would be in an H-PLMN and a roaming user would be in a V-PLMN. One method of identifying heavy users would be by the Quality of Service (QOS) level assigned to the user. Particularly heavy data users tend to be separated out by QoS by the provider. Fixed wireless users (also known as cellular home internet users) may be excluded from the pool of home network users in order to maintain their level of service and due to the fact that there are very few of them per cell.

The process of decreasing the BWP may comprise decreasing the BWP in increments while the capacity usage of the PUCCH remains above the threshold until the BWP reaches the smallest supported size. This process may be the same whether decreasing the BWP of roaming, users, heavy bandwidth users, or home network users. The process of downgrading the carrier aggregation may comprise removing one of the SCells from the carrier aggregation. This process may be the same whether downgrading the carrier aggregation of roaming users, heavy bandwidth users, or home network users. The capacity usage threshold may be set at any useable value by the wireless network provider. It may be configured to be static or dynamic, including being different depending on the time of day, or day of the week, for example. The schedule for the dynamic threshold may be any useable schedule.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of managing bandwidth in a wireless network, the method comprising:
monitoring a capacity usage of an uplink control channel;
upon determining that the capacity usage of the uplink control channel is above a threshold, lowering a Bandwidth Part (BWP) in one or more secondary carriers for one or more roaming users and one or more heavy bandwidth users.

2. The method of claim 1, further comprising:
upon determining that the capacity usage of the uplink control channel is still above the threshold after lowering the BWP in one or more secondary carriers for the one or more roaming users and the one or more heavy bandwidth users, downgrading a carrier aggregation level for the one or more roaming users and the one or more heavy bandwidth users.

3. The method of claim 2, further comprising:
upon determining that the capacity usage of the uplink control channel is still above the threshold after downgrading the carrier aggregation level for the one or more roaming users and the one or more heavy bandwidth users, lowering a BWP in one or more secondary carriers for one or more home network users.

4. The method of claim 3, further comprising:
upon determining that the capacity usage of the uplink control channel is still above the threshold after lowering the BWP in one or more secondary carriers for the one or more home network users, downgrading a carrier aggregation level for the one or more home network users.

5. The method of claim 4, wherein downgrading the carrier aggregation level comprises removing one SCell from the one or more SCells.

6. The method of claim 4, wherein the one or more roaming users are identified by determining the one or more roaming users are in a V-PLMN and the home network users are identified by determining the one or more home network users are in an H-PLMN.

7. The method of claim 4, wherein the heavy bandwidth users are identified by a QoS level assigned to each of the one or more heavy bandwidth users.

8. The method of claim 4, wherein the lowering the BWP comprises decreasing the BWP in increments while the capacity usage of the uplink control channel remains above the threshold, until the BWP is a smallest supported size.

9. A system, the system comprising:
an access node including at least one electronic processor configured to perform operations, the operations comprising:
monitoring a capacity usage of an uplink control channel;
upon determining that the capacity usage of the uplink control channel is above a threshold, lowering a Bandwidth Part (BWP) in one or more secondary cells for one or more roaming users and one or more heavy bandwidth users;
upon determining that the capacity usage of the uplink control channel is still above the threshold after lowering the BWP in one or more secondary cells for the one or more roaming users and the one or more heavy bandwidth users, downgrading a carrier aggregation level for the one or more roaming users and the one or more heavy bandwidth users;
upon determining that the capacity usage of the uplink control channel is still above the threshold after downgrading the carrier aggregation level for the one or more roaming users and the one or more heavy bandwidth users, lowering a BWP in one or more secondary cells for one or more home network users; and
upon determining that the capacity usage of the uplink control channel is still above the threshold after lowering the BWP in one or more secondary cells for the one or more home network users, downgrading a carrier aggregation level for the one or more home network users.

10. The system of claim 9, wherein the one or more roaming users are identified by determining the one or more roaming users are in a V-PLMN.

11. The system of claim 9, wherein the one or more home network users are identified by determining the one or more home network users are in an H-PLMN.

12. The system of claim 9, wherein the heavy bandwidth users are identified by a QoS level assigned to each of the one or more heavy bandwidth users.

13. The system of claim 9, wherein the lowering the BWP comprises decreasing the BWP in increments while the capacity usage of the uplink control channel remains above the threshold, until the BWP is a smallest supported size.

14. The system of claim 9, wherein downgrading the carrier aggregation level comprises removing one secondary cell from the one or more secondary cells.

15. A method of managing bandwidth in a wireless network, the method comprising:
monitoring a capacity usage of a Physical Uplink Control Channel (PUCCH) of a primary cell (PCell);
upon determining that the capacity usage of the PUCCH is above a threshold, lowering a Bandwidth Part (BWP) in one or more secondary cells (SCells) for one or more roaming users and one or more heavy bandwidth users;
upon determining that the capacity usage of the PUCCH is still above the threshold after lowering the BWP in one or more SCells for the one or more roaming users and the one or more heavy bandwidth users, downgrading a carrier aggregation level for the one or more roaming users and the one or more heavy bandwidth users;
upon determining that the capacity usage of the PUCCH is still above the threshold after downgrading the carrier aggregation level for the one or more roaming users and the one or more heavy bandwidth users, lowering a BWP in one or more SCells for one or more home network users; and
upon determining that the capacity usage of the PUCCH is still above the threshold after lowering the BWP of the one or more home network users, downgrading a carrier aggregation level for the one or more home network users.

16. The method of claim 15, wherein the one or more roaming users are identified by determining the one or more roaming users are in a V-PLMN.

17. The method of claim 15, wherein the one or more home network users are identified by determining the one or more home network users are in an H-PLMN.

18. The method of claim 15, wherein the heavy bandwidth users are identified by a QoS level assigned to each of the one or more heavy bandwidth users.

19. The method of claim 15, wherein the lowering the BWP comprises decreasing the BWP in increments while the capacity usage of the PUCCH remains above the threshold, until the BWP is a smallest supported size.

20. The method of claim 15, wherein downgrading the carrier aggregation level comprises removing one SCell from the one or more SCells.
